(19) United States
(12) Patent Application Publication
(10) Pub. No.: US 2025/0112686 A1
(43) Pub. Date: Apr. 3, 2025

(54) GNSS AND SATELLITE COMMUNICATION COEXISTENCE

(71) Applicant: Apple Inc., Cupertino, CA (US)

(72) Inventors: Aditya N. Srivastava, Fremont, CA (US); Richard Najarian, Palos Verdes Estates, CA (US); Bryan R. Townsend, Menlo Park, CA (US)

(21) Appl. No.: 18/589,102

(22) Filed: Feb. 27, 2024

Related U.S. Application Data
(60) Provisional application No. 63/541,225, filed on Sep. 28, 2023.

(51) Int. Cl. H04B 7/185; H04W 56/00

(52) U.S. Cl. CPC H04B 7/18513; H04W 56/0045

(57) ABSTRACT

User equipment detects interference with a global navigation satellite system (GNSS), as well as a time of when the interference occurs. The user equipment also receives a transmission time offset associated with the interference. In some embodiments, the user equipment determines a boundary of a frame based on the transmission time offset and the time of when the interference occurs. The user equipment then communicates with a non-terrestrial network based on the frame. Additionally or alternatively, the user equipment determines whether the time of when the interference occurs aligns with a frame cycle of the frame. If so, then the user equipment provides an indication of the interference or guidance to reduce or avoid the interference.

### CROSS-REFERENCE TO RELATED APPLICATIONS

This application claims to the benefit of U.S. Provisional Application No. 63/541,225, filed Sep. 28, 2023, entitled “GNSS and Satellite Communication Coexistence,” which is incorporated by reference herein in its entirety for all purposes.

### BACKGROUND

The present disclosure relates generally to satellite communication via a mobile communication device, and more specifically to coexistence between using a non-terrestrial network (NTN) and a global navigational satellite system (GNSS) network.

Due to GNSS in-band interference, devices (e.g., user equipment, mobile communication devices, smartphones, and so on) may not receive GNSS signals and may be prevented from communicating with or using NTNs, peer-to-peer (P2P) networks, or other standalone networks. This may be because, for communication on NTNs, P2P networks, or other standalone networks without a centralized time reference, a GNSS position, time estimate, and/or velocity estimate may be used to establish a connection. However, the GNSS in-band interference may prevent a device from receiving the GNSS position, time estimate, and/or velocity estimate.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, user equipment comprises: a transceiver configured to communicate with a non-terrestrial network; a global navigational satellite system (GNSS) receiver configured to receive signals from a GNSS; and processing circuitry coupled to the transceiver and the GNSS receiver, the processing circuitry configured to receive a transmission time offset; receive, at the GNSS receiver, interference; and communicate using the transceiver and a frame boundary based on the transmission time offset and the interference.

In another embodiment, user equipment comprises: a GNSS receiver front end configured to receive a signal from a GNSS, the GNSS receiver front end comprising an analog-to-digital converter (ADC) coupled to an interference detector, the interference detector configured to determine when interference is received; processing circuitry coupled to the GNSS receiver front end, the processing circuitry configured to determine a boundary of a frame used for satellite network communication based on the interference; and a satellite software-defined radio (SDR) modem coupled to the processing circuitry, the satellite SDR modem configured to communicate with a satellite network using the frame based on the boundary.

In yet another embodiment, a method comprises: receiving a transmission time offset; receiving, at a GNSS receiver, interference; and performing a mitigation action based on the interference aligning with a frame cycle.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of user equipment, according to embodiments of the present disclosure;

FIG. 2 is a functional diagram of the user equipment of FIG. 1, according to embodiments of the present disclosure;

FIG. 3 is a schematic diagram of a communication system that includes a global navigational satellite system (GNSS) network, a non-terrestrial network (NTN), and two devices that seek to communicate using the NTN, according to embodiments of the present disclosure;

FIG. 4 is a schematic diagram of a communication system that enables a victim device to synchronize with GNSS timing based on a transmission time offset and the in-band GNSS interference even in the presence of in-band GNSS interference caused by an aggressor device, according to embodiments of the present disclosure;

FIG. 5 is a flowchart of a method to synchronize with GNSS timing based on a transmission time offset and the in-band GNSS interference even in the presence of in-band GNSS interference caused by an aggressor device, according to embodiments of the present disclosure;

FIG. 6 is a block diagram of a process for confirming frame boundary hypotheses, according to embodiments of the present disclosure;

FIG. 7 is a block diagram of a GNSS receiver front end and a satellite software-defined radio (SDR) modem of the user equipment for FIG. 1, according to embodiments of the present disclosure;

FIG. 8 is a block diagram of a GNSS receiver front end and a satellite SDR modem of the user equipment of FIG. 1 that downconverts a digitized signal prior to detecting interference, according to embodiments of the present disclosure; and

FIG. 9 is a flowchart of a method to perform a mitigation action based on detecting in-band GNSS interference caused by an aggressor device, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to enabling coexistence between a non-terrestrial network (NTN) and a global navigational satellite system (GNSS) network. Due to GNSS in-band interference, devices (e.g., user equipment, mobile communication devices, smartphones, and so on) may not receive GNSS signals and may be prevented from communicating with or using NTNs, peer-to-peer (P2P) networks, or other standalone network. For example, NTN signals having a frequency in the L band (e.g., 1 to 2 gigahertz (GHz)) may interfere with GNSS signals. Moreover, nearby devices that are attempting to establish an NTN connection may first seek to acquire a GNSS time and/or position, but may be unable to do so due to the interference.

In the disclosed embodiments, when some information about an interference source is known, an electronic device may avoid or remove an absolute timing reliance from GNSS signals prior to attempting NTN communication. The electronic device may further avoid or remove position reliance on GNSS at a time of communication. Additionally, if a velocity estimate is needed, the electronic device may determine the velocity estimate using inertial techniques or other techniques. In particular, the disclosed embodiments may enable detection of when the interference occurs, and provide times to communicate with an NTN while reducing or avoiding the interference, or provide an indication of the interference or how to avoid the interference.

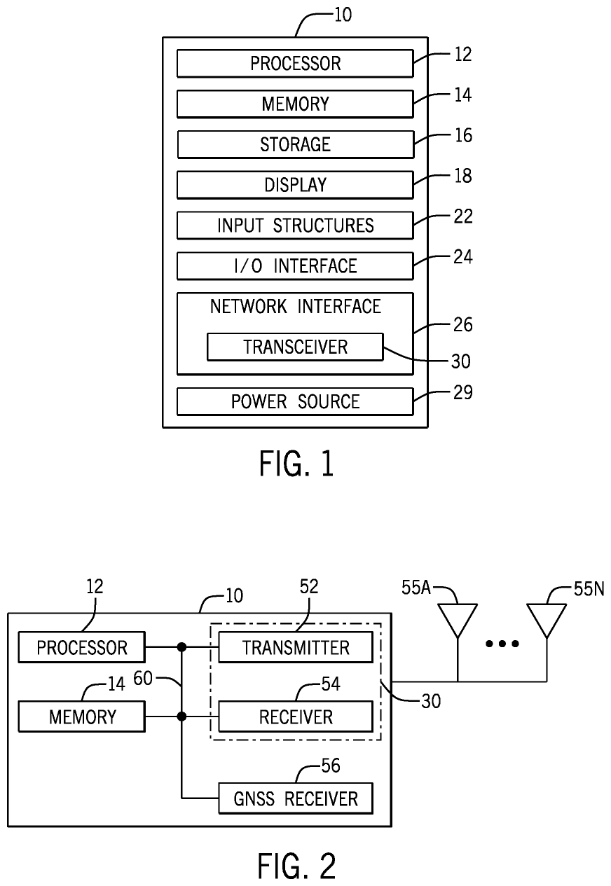

With the foregoing in mind, FIG. 1 is a block diagram of user equipment 10 (e.g., an electronic device or a mobile communication device), according to embodiments of the present disclosure. The user equipment 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, the memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the user equipment 10.

By way of example, the user equipment 10 may include any suitable computing device, including a desktop or notebook computer, a portable electronic or handheld electronic device, such as a wireless electronic device or smartphone, a tablet, a wearable electronic device, and other similar devices. It should be noted that the processor 12 and other related items in FIG. 1 may be generally referred to herein as “data processing circuitry.” Such data processing circuitry may be embodied wholly or in part as software, hardware, or both. Furthermore, the processor 12 and other related items in FIG. 1 may be a single contained processing module or may be incorporated wholly or partially within any of the other elements within the user equipment 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the user equipment 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the user equipment 10 to provide various functionalities.

In certain embodiments, the display 18 may facilitate users to view images generated on the user equipment 10. In some embodiments, the display 18 may include a touch screen, which may facilitate user interaction with a user interface of the user equipment 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the user equipment 10 may enable a user to interact with the user equipment 10 (e.g., pressing a button to increase or decrease a volume level). The I/O interface 24 may enable the user equipment 10 to interface with various other electronic devices, as may the network interface 26. In some embodiments, the I/O interface 24 may include an I/O port for a hardwired connection for charging and/or content manipulation using a standard connector and protocol, such as a universal serial bus (USB) or other similar connector and protocol.

The network interface 26 may include, for example, one or more interfaces for a peer-to-peer connection, a personal area network (PAN), such as an ultra-wideband (UWB) or a BLUETOOTH® network, for a local area network (LAN) or wireless local area network (WLAN), such as a network employing one of the IEEE 802.11x family of protocols (e.g., WI-FI®), and/or for a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, New Radio (NR) cellular network, 6^{th} generation (6G) cellular network and beyond, a satellite connection (e.g., via an NTN), and so on. In particular, the network interface 26 may include, for example, one or more interfaces for using a Release-15 cellular communication standard of the 5G specifications that include the millimeter wave (MM Wave) frequency range (e.g., 24.25-300 gigahertz (GHz)). The network interface 26 of the user equipment 10 may allow communication over the aforementioned networks (e.g., 5G, Wi-Fi, LTE-LAA, and so forth). The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, UWB network, alternating current (AC) power lines, and so forth.

The network interface 26 may, for instance, include a transceiver 30 for communicating signals using one of the aforementioned networks. The network interface 26 may also include a global navigation satellite system (GNSS) receiver. The user equipment 10 may detect or receive interference at the GNSS receiver, as well as a time of when the interference occurs. The user equipment 10 may also receive, via the transceiver 30, a transmission time offset associated with the interference. In some embodiments, the user equipment 10 may determine a boundary of a frame based on the transmission time offset and the time of when the interference occurs. The user equipment 10 may then communicate with a non-terrestrial network. using the transceiver 30, based on the frame. Additionally or alternatively, the user equipment 10 may determine whether the time of when the interference occurs aligns with a frame cycle of the frame. If so, then the user equipment 10 may provide an indication of the interference or guidance to reduce or avoid the interference. The power source 29 of the user equipment 10 may include any suitable source of power, such as a rechargeable lithium polymer (Li-poly) battery and/or an alternating current (AC) power converter.

FIG. 2 is a functional diagram of the user equipment 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55), and/or a GNSS receiver 56 may be communicatively coupled directly or indirectly (e.g., through or via another component, a communication bus, a network) to one another to transmit and/or receive signals between one another.

The user equipment 10 may include the transmitter 52 and/or the receiver 54 that respectively transmit and receive signals between the user equipment 10 and an external device via, for example, a network (e.g., including base stations) or a direct connection. As illustrated, the transmitter 52 and the receiver 54 may be combined into the transceiver 30. The user equipment 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The user equipment 10 may include multiple transmitters, multiple receivers, multiple transceivers, and/or multiple antennas as suitable for various communication standards. For example, the user equipment 10 may include a first transceiver to send and receive messages using a first wireless communication network, a second transceiver to send and receive messages using a second wireless communication network, and a third transceiver to send and receive messages using a third wireless communication network, though any or all of these transceivers may be combined in a single transceiver. In some embodiments, the transmitter 52 and the receiver 54 may transmit and receive information via other wired or wireline systems or means.

The user equipment 10 may include the GNSS receiver 56 that may enable the user equipment 10 to receive GNSS signals from a GNSS that includes one or more GNSS satellites or GNSS ground stations. The GNSS signals may include timing information, such as Global Positioning System (GPS) date, satellite clock correction information, satellite status, and so on. The user equipment 10 may compare the timing information in the GNSS signals with internal clock signals (e.g., from an oscillator). The user equipment 10 may adjust the internal clock signals based on the timing information. The GNSS signals may also include a GNSS satellite's observation data, broadcast orbit information of tracked GNSS satellites, and supporting data, such as meteorological parameters, collected from co-located instruments of a GNSS satellite. For example, the GNSS signals may be received from a Global Positioning System (GPS) network, a Global Navigation Satellite System (GLONASS) network, a BeiDou Navigation Satellite System (BDS), a Galileo navigation satellite network, a Quasi-Zenith Satellite System (QZSS or Michibiki) and so on. The GNSS receiver 56 may process the GNSS signals to determine a global position of the user equipment 10.

As illustrated, the various components of the user equipment 10 may be coupled together by a bus system 60. The bus system 60 may include a data bus, for example, as well as a power bus, a control signal bus, and a status signal bus, in addition to the data bus. The components of the user equipment 10 may be coupled together or accept or provide inputs to each other using some other mechanism.

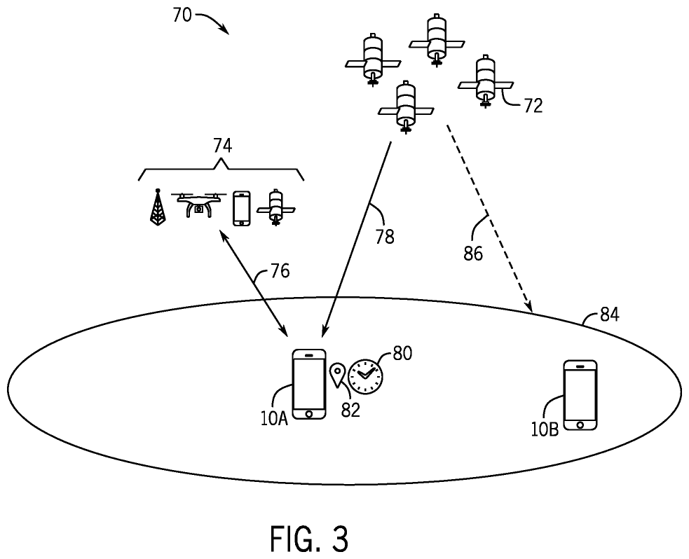

With the preceding in mind, FIG. 3 is a schematic diagram of a communication system 70 that includes a GNSS 72, an NTN 74, and two devices 10A, 10B (collectively 10) that seek to communicate using the NTN 74. It should be understood that the devices 10 may include or be in the form of the user equipment 10. The NTN 74 may include a global navigation satellite system (GNSS) network, a non-terrestrial network, or any other suitable wireless communication network. Moreover, the NTN 74 is provided as an example, and in additional or alternative embodiments, the NTN 74 may instead be a terrestrial network, such as a radio access network (RAN), a WLAN, a PAN, and so on.

The NTN 74 may include multiple communication nodes communicatively coupled together. The communication nodes may include any suitable electronic device, such as non-terrestrial base stations, satellites, high-altitude platform stations, airborne base stations, space borne base stations, or any other suitable nonstationary or stationary communication devices (as illustrated), communicatively coupled to the devices 10. In additional or alternative embodiments, the communication node may include base stations, such as Next Generation NodeB (gNodeB or gNB) base stations and may provide 5G/NR coverage to the devices 10, Evolved NodeB (eNodeB) base stations and may provide 4G/LTE coverage to the devices 10, and so on.

The devices 10 may communicate with the NTN 74 by transmitting a signal via their respective transmitters 52, which may be directed to at least one of the communication nodes of the NTN 74 (e.g., using an uplink process). Each of the communication nodes may include transceivers 30 to receive signals from the devices 10 and/or any other suitable device transmitting signals to the communication nodes. In this way, the NTN 74 may receive the signal, process the signal, and/or relay or transmit an additional signal back to the devices 10 and/or to an additional device (e.g., using a downlink process). For example, a device 10 may receive the signal from the NTN 74 via the receiver 54. Upon receiving the signal, the device 10 may process the signal to obtain information associated with the signal.

In particular, the first device 10A may seek to start an NTN, P2P, or other communication session 76 with another device or infrastructure (e.g., via the NTN 74). It may start with receiving and decoding GNSS signals 78 to get a time reference 80 and position and velocity estimates 82. In this way, the first device 10A may determine its position and precise time from the GNSS signals 78. Using the precise time and position from the GNSS 72, the first device 10A starts NTN/P2P/other communication 76, and may leak transmission energy 84 (e.g., interference) in GNSS L1 and/or L5 bands. This GNSS band interference 84 may envelop or cover an area that includes nearby the second device 10B. This area may be of any range where the interference 84 occurs (e.g., 5 meters (m) or less, 10 m or less, 15 m or less, 20 m or less, 20 m or more, and so on). As a result, the second device 10B may not receive GNSS/GPS signals 86 and thus be denied GNSS/GPS service for precise time determination, which may prohibit or prevent it from participating in NTN, P2P, other communication 76 that is available to the first device 10A.

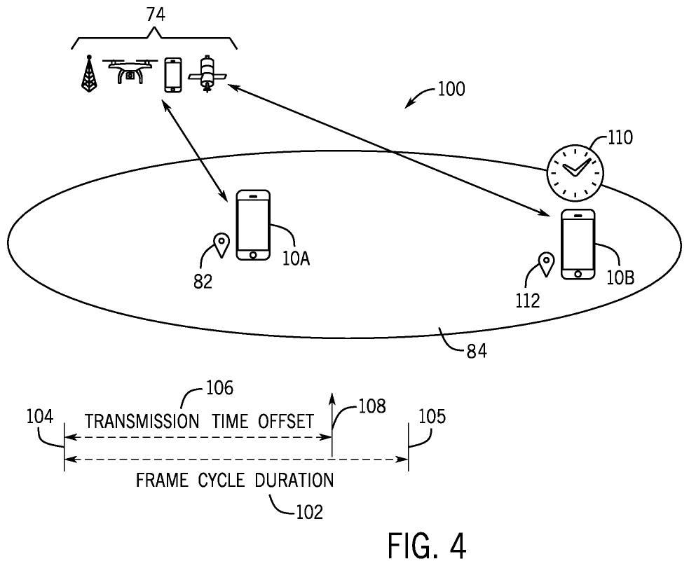

FIG. 4 is a schematic diagram of a communication system 100 that enables the second device 10B (e.g., a victim device) to synchronize with GNSS timing based on a transmission time offset and the in-band GNSS interference 84 even in the presence of the in-band GNSS interference 84 caused by the first device 10A (e.g., an aggressor device), according to embodiments of the present disclosure. A frame cycle duration 102 of the GNSS 72 is illustrated. As may be appreciated, communications to and from NTN network 74 may be synchronized with the GNSS 72. As such, when the first device 10A determines when the frame cycle duration 102 begins (e.g., at the left edge 104 of the frame cycle duration 102), then it also determines when a frame cycle duration of the NTN 74 begins, and it may begin communicating with the NTN 74. In some embodiments, the first device 10A may additionally or alternatively determine when the frame cycle duration 102 ends (e.g., at the right edge 105 of the frame cycle duration 102). However, because the second device 10B is within the area of the interference 84 of the first device 10A, the second device 10B may not communicate with the GNSS 72, and thus not establish communication 86 with the NTN 74.

A transmission time offset 106 is a duration of time after the beginning 104 of the frame cycle duration 102 that a transmission or transmit burst (e.g., an interference GNSS or GPS energy, the in-band GNSS interference 84) sent by the first device 10A may be observed and/or received by the GNSS receiver 56 of the second device 10B, such as at interference time 108. The transmission time offset 106 may occur at the same interval within the frame cycle duration 102. As an example, the transmission occurring at the interference time 108 may be an NTN transmission in the L band. The frame cycle duration 102 may be 1 second or more, 2 seconds or more, such as 2.56 seconds, and the transmission time offset 106 may be 0.5 seconds or more, 1 second or more, 1.5 seconds or more, such as 1.96 seconds. The second device 10B may have its own clock that may not be synchronized with GNSS timing, but may determine the time of the transmission time offset 106. In some embodiments, the transmission time offset 106 may be sent to the second device 10B (e.g., by the first device 10A, a cellular and/or terrestrial network communicatively coupled to first device 10A and/or the second device 10B, the NTN 74, and so on). As such, the second device 10B may determine the beginning of the frame cycle duration 102 based on the transmission time offset 106 and the interference time 108 based on its own clock. The second device 10B may then synchronize its clock 110 with the GNSS frame cycle duration 102, thus enabling it to communicate with the NTN 74 (or other communication network) where GNSS timing is a prerequisite and/or estimate its position 112. While the disclosure refers to the transmission time offset 106 as a time after the beginning 104 of the frame cycle duration 102 and the second device 10B synchronizing its clock based on the transmission time offset 106 and the beginning 104 of the frame cycle duration 102, it should be understood that the transmission time offset 106 may additionally or alternatively be determined as a time before the end 105 of the frame cycle duration 102 and the second device 10B may synchronize its clock based on the transmission time offset 106 and the end 105 of the frame cycle duration 102.

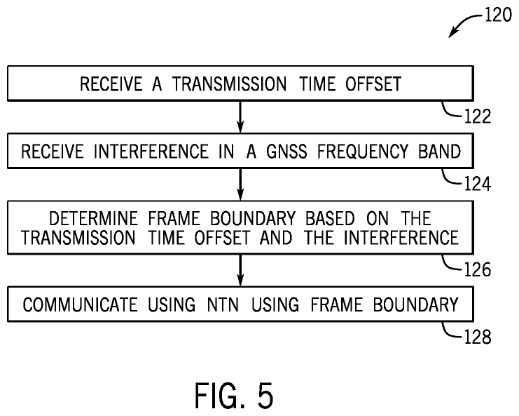

FIG. 5 is a flowchart of a method 120 to synchronize with GNSS timing based on a transmission time offset 106 and the in-band GNSS interference 84 even in the presence of the in-band GNSS interference 84 caused by an aggressor device (e.g., the first device 10A), according to embodiments of the present disclosure. In process block 122, the victim device (e.g., the second device 10B) may receive the transmission time offset 106. In some embodiments, the transmission time offset 106 may be predetermined or known by the victim device 10B. For example, the transmission time offset 106 may be sent by a cellular and/or terrestrial network communicatively coupled to the aggressor device 10A and/or the victim device 10B, the NTN network 74, and/or the aggressor device 10A (e.g., via a sidelink, other direct device-to-device communication link, or a P2P network), and received by the receiver 54 of the victim device 10B. In process block 124, the victim device 10B may also receive interference 84 in a GNSS frequency band (e.g., via the GNSS receiver 56 of the victim device 10B). In process block 126, processing circuitry 12 of the victim device 10B may then determine a frame boundary (e.g., a beginning 104, end 105, or edge of the frame cycle duration 102) of the GNSS 72 and/or the NTN 74 based on the transmission time offset 106, which may in turn be based on the interference time 108 (e.g., as provided by a clock of the victim device 10B). For example, the processing circuitry 12 may determine a difference between or subtract the transmission time offset 106 and the interference time 108 (e.g., the time the GNSS receiver 56 received the interference 84) to determine a frame boundary 104, 105. In process block 128, the victim device 10B may then communicate with or use the NTN 74 based on or using the frame boundary 104, 105. In particular, the victim device 10B may transmit signals using its transmitter 52 and/or receive signals using its receiver 54 to and/or from the NTN 74 with timing based on the frame boundary 104. 105. For example, the victim device 10B may receive downlink NTN signals via the receiver 54 and based on the timing of the frame boundary 104, 105 to establish communication with the NTN 74. In this manner, the victim device 10B may perform NTN communication without receiving GNSS information or signals from the GNSS 72, thus avoiding waiting until the interference 84 is over.

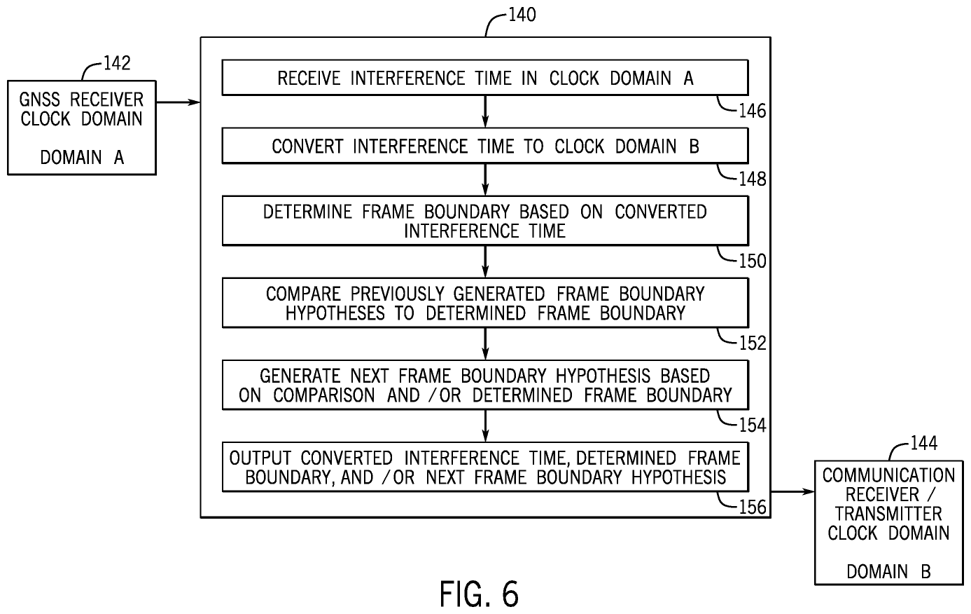

FIG. 6 is a block diagram of a process 140 for confirming frame boundary hypotheses, according to embodiments of the present disclosure. A frame boundary hypothesis may include an estimate of a frame boundary (e.g., 104, 105) generated by the processing circuitry 12 of the victim device 10B. Hypothesizing a frame boundary may be useful because, in some cases, there may be a randomized offset for each device 10 after the transmission time offset 106 (e.g., within a time period of 1 millisecond). That is, the GNSS 72 may allocate a different time period for each device 10 after the transmission time offset 106 for which to transmit, where each of the time periods for each device 10 start at a randomized transmission time offset 106 as the different time periods may not be known to victim devices. In particular, clock domain A 142 may correspond to a synchronized (e.g., with the GNSS) clock domain, and clock domain B 144 may correspond to an unsynchronized victim device clock domain, such as that of the receiver 54 and/or the transmitter 52 of the victim device 10B. As the interference 84 is generated in the aggressor device 10A that is synchronized with the GNSS 72 and thus in clock domain A 142, the processing circuitry 12 of the victim device 10B receives, in process block 146, the interference time 108 in clock domain A 142. In process block 148, the processing circuitry 12 converts or translates the interference time 108 into the clock domain B 144 (within which the victim device 10B is operating). In process block 150, the processing circuitry 12 determines the frame boundary (e.g., a beginning 104 of the frame cycle duration 102 and/or an end 105 of the frame cycle duration 102) based on the converted interference time 108. In process block 152, the processing circuitry 12 compares previously generated frame boundary hypotheses to the determined frame boundary. In particular, the processing circuitry 12 may confirm accuracy of any previously generated frame boundary hypotheses by determining whether they correctly hypothesized the determined frame boundary. In some embodiments, the processing circuitry 12 may remove any previously generated frame boundary hypotheses that did not correctly hypothesize the determined frame boundary (e.g., within a threshold measure of accuracy) and keep any previously generated frame boundary hypotheses that correctly hypothesized the determined frame boundary (e.g., within the threshold measure of accuracy).

In process block 152, the processing circuitry 12 generates one or more next frame boundary hypotheses based on the comparison and/or the determined frame boundary. In some embodiments, the processing circuitry 12 may store the next frame boundary hypotheses with the previously generated frame boundary hypotheses (e.g., in the memory 14 and/or the storage 16) for future comparison (e.g., in future iterations of the process 140). The hypotheses may be generated using any suitable optimization or estimation technique, such as using a Kalman filter. In process block 154, the processing circuitry 12 outputs the converted interference time, determined frame boundary, and/or the next frame boundary hypothesis. Any of the converted interference time, determined frame boundary, and the next frame boundary hypotheses may then be used by the victim device 10B to communicate with the NTN 74. For example, the processing circuitry 12 may use the converted interference time to determine or extrapolate the frame boundary, and use the frame boundary to synchronize with GNSS timing to communicate with the NTN 74. In another example, the processing circuitry 12 may simply use the determined frame boundary to synchronize with GNSS timing to communicate with the NTN 74. In yet another example, the processing circuitry 12 may use a next frame boundary hypothesis as the frame boundary and use it to communicate with the NTN 74. The processing circuitry 12 may repeat the process 140 for multiple iterations, increasing the confidence in the stored boundary hypotheses. At any point, in some embodiments, the processing circuitry 12 may select the boundary hypothesis with the highest accuracy (e.g., when compared to a presently determined frame boundary) and use it as the frame boundary to communicate with the NTN 74. In this manner, the process 140 enables the victim device 10B to confirm a frame boundary hypothesis and use it to communicate with the NTN 74.

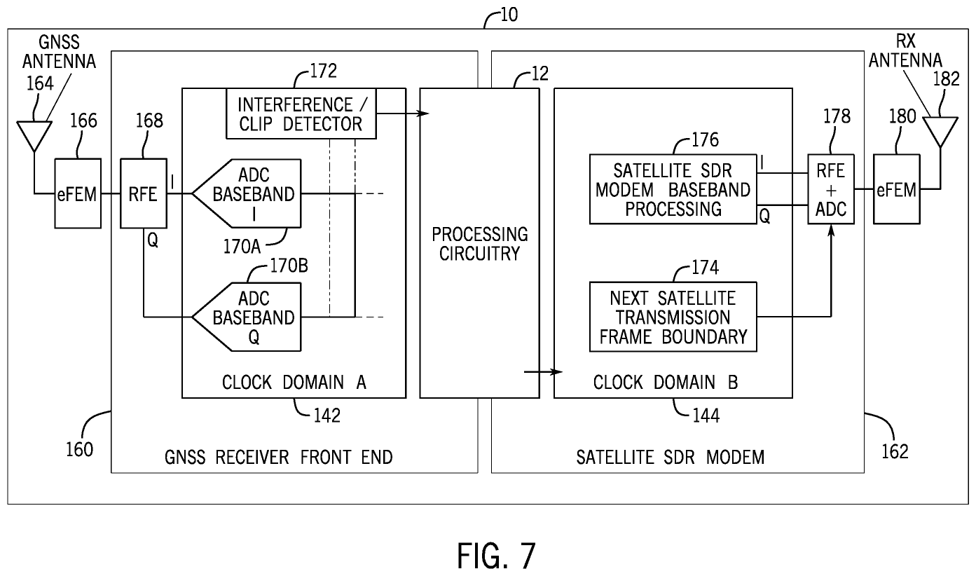

FIG. 7 is a block diagram of a GNSS receiver front end 160 and a satellite software-defined radio (SDR) modem 162 of the user equipment 10, according to embodiments of the present disclosure. As illustrated, the GNSS receiver front end 160 may operate in clock domain A 142, while the SDR modem 162 may operate in clock domain B 144. A GNSS antenna 164 may be coupled to an external front end module (eFEM) 166 and/or external low noise amplifiers (LNAs), which may be in turn coupled to an on-device (e.g., on the GNSS receiver front end) radio front end (RFE) 168 that may include on-device filters and/or on-device LNAs. The RFE 168 may be coupled to ADCs 170A, 170B (collectively 170) that may digitize incoming GNSS signals, which may each be coupled to an interference/clip detector 172 that detects interference (e.g., 84) in the digitized signals. In particular, the interference/clip detector 172 may detect interference 84 if it detects a magnitude of an I (in-phase) and/or Q (quadrature) sample is greater than a threshold magnitude. While the interference/clip detector 172 is shown to be coupled downstream or after the ADCs 170, it should be understood that in additional or alternative embodiments, the interference/clip detector 172 may be coupled in any suitable configuration, such as after the RFE 168 (and upstream of or before the ADCs 170). Moreover, the interference/clip detector 172 may detect when (e.g., the interference time 108) the interference 84 occurs (e.g., relative to an internal clock of the user equipment 10). For example, the interference/clip detector 172 may determine or detect the interference time 108, a duration of the interference 84, a periodicity of the interference 84, whether there is a “quiet” time (e.g., a duration at which the interference 84 does not occur), and so on.

As discussed with FIG. 6, the processing circuitry 12 may convert signals from clock domain A 142 to clock domain B 144. The processing circuitry 12 may also generate multiple frame boundary hypotheses based on the time at which the interference begins (e.g., the interference time 108) and the predetermined frame cycle duration 102, and each may be checked to confirm whether the next interference time 108 corresponds to a respective hypothesis. The processing circuitry 12 may select a frame boundary hypothesis (e.g., by comparing it to a presently determined frame boundary, by selecting a frame boundary hypothesis with an increased or highest accuracy), and use that frame boundary hypothesis to communicate with the NTN 74. In particular, the processing circuitry 12 may determine a next satellite transmission frame 174 based on the confirmed frame boundary, and the satellite SDR modem 162 may communicate with (e.g., transmit signals to or receive signals from) the NTN 74 using the next satellite transmission frame 174. As illustrated, the satellite SDR modem 162 may include satellite SDR modem baseband processing circuitry 176 coupled to an RFE and ADC 178, which are in turn coupled to an eFEM 180, which is coupled to an antenna 182 (e.g., an NTN receiving antenna).

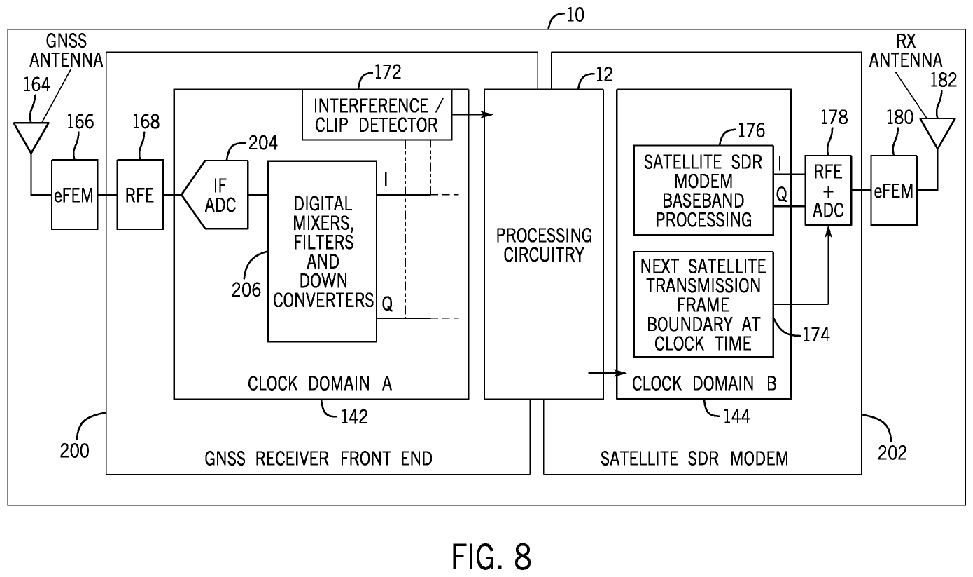

FIG. 8 is a block diagram of a GNSS receiver front end 200 and a satellite SDR modem 202 of the user equipment 10 that downconverts a digitized signal prior to detecting interference (e.g., 84), according to embodiments of the present disclosure. As illustrated, after an intermediate frequency (IF) ADC 204 digitizes a received GNSS signal, digital mixers, filters, and downconverters 260 may mix, filter, and downconvert the digitized signal, which then may be received by the interference/clip detector 172. Advantageously, the downconverted signal may be of lower frequency, so the interference/clip detector 172 may detect the interference 84 at a lower rate, which may be a lower cost option when compared to that of FIG. 6.

In some embodiments, after determining or detecting the interference 84 (e.g., start time, stop time, duration, periodicity, the interference time 108, and so on), the user equipment 10 may perform a mitigation action different than determining a time outside of the interference period for which to communicate with the NTN 74. For example, the mitigation action may include providing (e.g., displaying, sending, outputting via an audio device) an alert, message, or other guidance to move away from the interfering or aggressor device (e.g., 10A). In some embodiments, the guidance may display an indication of a direction (e.g., display an arrow) on the display 18 for which a user may follow to move away from the interfering device 10A (e.g., to move out of the area that is affected by the interference 84). In additional or alternative embodiments, the alert, message, or other guidance may indicate that the interference 84 exists so that the user may be informed and may avoid a more negative user experience. In another embodiment, the alert, message, or other guidance may indicate a source of the interference 84 (e.g., another user equipment 10A, another GNSS, such as Beidou, interfering with a desired GNSS, such as GPS, and so on). Moreover, the user equipment 10 may determine that the interference 84 (e.g., interference time 108) aligns with a frame cycle and/or a quiet period of the frame cycle, and if the user equipment 10 determines that the interference 84 has not occurred for a threshold number of frame cycles, then the user equipment 10 may begin NTN transmission.

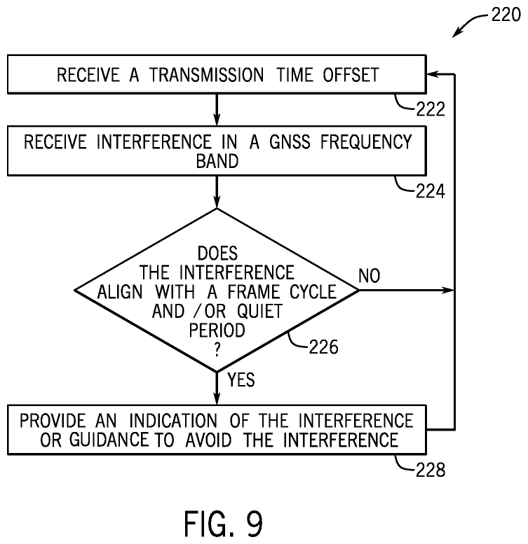

FIG. 9 is a flowchart of a method 220 to perform a mitigation action based on detecting in-band GNSS interference 84 caused by an aggressor device (e.g., the first device 10A), according to embodiments of the present disclosure. As with the method of FIG. 5, in process block 222, the victim device (e.g., the second device 10B) receives a transmission time offset 106. In process block 224, the victim device 10B also receives interference 84 in a GNSS frequency band (e.g., via the GNSS receiver 56 of the victim device 10B). In decision block 226, the victim device 10B determines whether the interference 84 (e.g., the interference time 108) aligns with a frame cycle and/or a quiet period of the frame cycle. For example, the processing circuitry 12 of the victim device 10B may determine whether the interference 84 falls within the frame cycle duration 102 and/or a predetermined quiet period within the frame cycle duration 102. If not, then the interference 84 may be random or unpredictable, and the method 220 may end or return to the beginning. However, if the interference 84 (e.g., the interference time 108) aligns with a frame cycle and/or the quiet period, then, in process block 228, the victim device 10B performs a mitigation action as described above, such as providing an indication of the interference or guidance to avoid the interference. In this manner, the user may be provided with information related to the interference 84 and/or how to reduce or avoid the interference 84.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. User equipment comprising:
a transceiver configured to communicate with a non-terrestrial network;
a global navigational satellite system (GNSS) receiver configured to receive signals from a GNSS; and
processing circuitry coupled to the transceiver and the GNSS receiver, the processing circuitry configured to
receive a transmission time offset;
receive, at the GNSS receiver, interference; and
communicate using the transceiver and a frame boundary based on the transmission time offset and the interference.

2. The user equipment of claim 1, wherein the transmission time offset is predetermined.

3. The user equipment of claim 1, wherein the processing circuitry is configured to receive the transmission time offset from the non-terrestrial network.

4. The user equipment of claim 1, wherein the interference is caused by an additional user equipment.

5. The user equipment of claim 4, wherein the processing circuitry is configured to receive the transmission time offset from the additional user equipment via a terrestrial network.

6. The user equipment of claim 1, wherein the processing circuitry is configured to receive the transmission time offset via a sidelink.

7. The user equipment of claim 1, wherein the processing circuitry is configured to determine a time that the interference occurs.

8. The user equipment of claim 7, wherein the processing circuitry is configured to determine the frame boundary based on the transmission time offset and the time that the interference occurs.

9. The user equipment of claim 8, wherein the processing circuitry is configured to hypothesize a next frame boundary based on comparing one or more previously hypothesized frame boundaries to the frame boundary.

10. User equipment comprising:
a global navigational satellite system (GNSS) receiver front end configured to receive a signal from a GNSS, the GNSS receiver front end comprising an analog-to-digital converter (ADC) coupled to an interference detector, the interference detector configured to determine when interference is received;
processing circuitry coupled to the GNSS receiver front end, the processing circuitry configured to determine a boundary of a frame used for satellite network communication based on the interference; and
a satellite software-defined radio (SDR) modem coupled to the processing circuitry, the satellite SDR modem configured to communicate with a satellite network using the frame based on the boundary.

11. The user equipment of claim 10, wherein the GNSS receiver front end comprises a frequency downconverter coupled between the ADC and the interference detector.

12. The user equipment of claim 10, wherein the processing circuitry is configured to generate a plurality of hypotheses for the boundary of the frame.

13. The user equipment of claim 10, wherein the GNSS receiver front end operates in a first clock domain and the satellite SDR modem operates in a second clock domain.

14. The user equipment of claim 13, wherein the processing circuitry is configured to convert between the first clock domain and the second clock domain.

15. A method comprising:
receiving a transmission time offset;
receiving, at a global navigational satellite system (GNSS) receiver, interference; and
performing a mitigation action based on the interference aligning with a frame cycle.

16. The method of claim 15, wherein the transmission time offset comprises a time after a start of the frame cycle that user equipment is permitted to transmit a non-terrestrial network signal.

17. The method of claim 16, wherein the non-terrestrial network signal is in an L band.

18. The method of claim 15, comprising determining that the interference aligns with the frame cycle.

19. The method of claim 15, wherein the mitigation action comprises providing an indication that the interference exists, and providing an indication to move away from the interference.

20. The method of claim 15, comprising communicating, using a transceiver, frame boundary based on the transmission time offset and the interference.
